(19) United States
(12) Patent Application Publication
(10) Pub. No.: US 2004/0057188 A1
(43) Pub. Date: Mar. 25, 2004

(54) System and method for providing telephone service restrictions

(75) Inventors: Bruce A. Phillips, Erie, CO (US); Marc A. Wernli, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO

(21) Appl. No.: 10/254,157

(22) Filed: Sep. 24, 2002

(51) Int. Cl. H02H 1/00

(52) U.S. Cl. 361/119

(57) ABSTRACT

A telecommunications network is provided which includes a protector device for protecting an associated telecommunications line. The protector device protects the associated telecommunications line from hazardous voltages and/or currents. Further, and in accordance with the present invention, the protector device also protects the associated telecommunications line from unauthorized use. The protector device regulates the class of service provided over the associated telecommunications line. A filter circuit integral with the protector device can be readily configured to pass or block signal frequencies depending on the class of service purchased.

### BACKGROUND OF THE INVENTION

As a result of regulatory changes in the telecommunications industry, incumbent local exchange carriers or “ILECs” (i.e., the traditional phone companies that often provide most or all telephone service in certain geographic areas) have opened up their telephone networks to competitive local exchange carriers (CLECs). CLECs have been given the right to “purchase” various elements of the ILECs network in order to provide telecommunications services to subscribers. The pricing of these elements can be complex and awkward to administer.

For example, the CLEC may purchase a “local loop” (the telephone line connecting the subscriber to the ILEC's central office) in order to offer either traditional voice telephone service or more advanced (higher speed) and more costly data services, such as DSL, ISDN, etc. The cost of the element will typically be based on the type of service that the CLEC intends to offer, with a local loop for traditional voice telephone service priced much lower than more advanced services.

One problem that has arisen in this environment is that a CLEC will purchase a local loop for one class of service, but later begins offering a more advanced service over that local loop. This not only deprives the incumbent phone company of revenue that it might otherwise be entitled to, but also leads to problems in the network. The more advanced services often operate at higher frequencies and use higher-powered signals, and can cause problems with other adjacent lines if the adjacent lines have not been conditioned to accommodate the higher-powered signals.

### BRIEF SUMMARY OF THE INVENTION

Embodiments of the present invention are directed to a system and method for providing fault protection and service restrictions. In accordance with one embodiment of the invention, a telecommunications network is provided. The telecommunications network includes a central office and subscriber equipment. The network also includes a plurality of telecommunications lines interconnecting the central office and the subscriber equipment. The network further includes a plurality of connection devices or protectors, each protector associated with one of the telecommunications lines and, in one disclosed embodiment, for protecting the network against hazardous or undesirable signals present on the associated telecommunications lines. The network also includes a service regulating or restricting module (a filter in one embodiment) associated and integral with at least one protector, for regulating the class of service provided over the telecommunications line associated with the protector.

In another embodiment of the present invention, there is provided a device for protecting and regulating service over a local loop. This device includes a protector housing and a protective circuit for protecting the network against hazardous signals present on the associated telecommunications line. The device further includes electrical pins which extend from the protector housing and are used for connection to a telecommunications line at a distribution panel. In accordance with the present invention, the protector device also includes a service regulating or restricting circuit. The service regulating circuit regulates the class of service provided over the telecommunications line. This circuit can be readily designed to pass or block signals depending on the class of service.

In still another embodiment of the present invention, there is provided a method for regulating service over a local loop. The method involves providing a protector device for connecting to a telecommunications line and for protecting the line against hazardous signals which may pass through the line. The method also involves providing, with the protector device, a service restricting or regulating circuit for blocking certain classes of service. For example, if the CLEC has purchased the local loop for use with ADSL, the service regulating module would prevent any higher frequency signals (such as for use with VDSL) from passing through on the line.

Further features of the present invention, as well as the structure and operation of various embodiments of the present invention, are described in detail below with respect to the accompanying drawings.

### BRIEF DESCRIPTION OF THE DRAWINGS

In the Figures, similar components and/or features may have the same or similar reference number or label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a simplified block diagram illustrating a telecommunications network, including central office equipment, a distribution panel, and outside telephone equipment, in accordance with the present invention.

FIG. 2 is a partial perspective view of a protector device and a distribution panel in accordance with the present invention.

FIG. 3 is a schematic diagram of the protector device illustrated in FIG. 2.

FIG. 4 is a schematic diagram of the filter circuit within the protector device of FIG. 3.

### DETAILED DESCRIPTION OF THE INVENTION

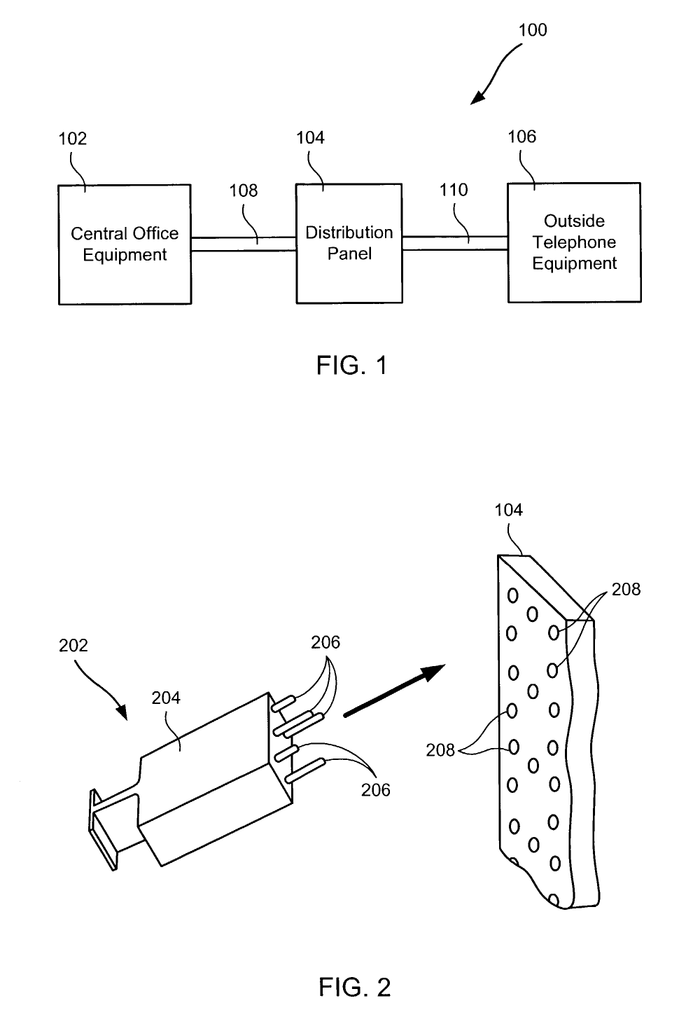

There are numerous configurations for implementing the present invention. One such configuration is seen in FIG. 1 where, according to an embodiment of the present invention, a telecommunications network 100 includes central office equipment 102, a distribution panel 104, and outside telephone (subscriber) equipment 106. As illustrated, the central office equipment 102, the distribution panel 104, and the outside telephone equipment 106 are interconnected by a plurality of telecommunications lines 108, 110. Central office equipment 102 is conventional and mostly comprises switches, cable distribution frames, batteries, etc. Central office equipment 102 is usually located at the telephone company (ILEC) central office. Outside telephone equipment 106 is also conventional and mostly comprises subscriber devices (e.g., telephones), loops, lines, and converters, etc. Outside telephone equipment 106 may be located at a distance from the central office, such as at a subscriber's house or business.

The distribution panel 104 (also known as a distribution frame), is a panel which connects central office lines 108 to outside lines 110. The central office lines 108 and outside lines 110 are connected to each other at the distribution panel using jumper wires and protector devices. While the distribution panel 104 is usually located at the central office, it should be appreciated that the distribution panel 104 may be located elsewhere in the network. The network described thus far is conventional and well known in the art.

Referring now to FIG. 2, there is shown a protector device 202 for use with the distribution panel 104 (only a portion of which is seen in FIG. 2). As illustrated, the protector device 202 includes a protector housing 204 and a plurality of electrical pins 206 which extend from the protector housing 204 and are used to make electrical connections at the distribution panel 104, typically connecting one (a twisted pair) of the lines 108 to an associated one (twisted pair) of the lines 110, at the distribution panel. While the number of pins 206 may vary (depending on the configuration of the panel 104), in the illustrated embodiment, there are five pins, two for connection to the central office lines 108 (tip and ring), two for connection to the outside lines 110 (tip and ring) and a grounding pin. Electrical pins 206 are inserted into connector sockets 208 at the distribution panel 104 in order for the protector device 202 to interconnect the lines at the distribution panel 104 and thereby pass signals between the central office equipment 102 and the subscriber equipment 106.

While not shown in FIG. 2, it will be appreciated by those skilled in the art that at a typical distribution panel there may be hundreds (or more) of protector devices 204, each having its pins 206 inserted at the distribution panel for connecting one of the associated central office lines to one of the outside lines at the panel.

The protector device 202 (also known as a protector block), is used to protect connected equipment (particularly costly equipment at the general office), from excessive voltage and/or excessive current. These hazardous or undesirable voltages and currents (usually originating outside the central office) are shunted to ground. For example, protector device 202 minimizes danger in areas which endure many lightning storms, as well as other sources of electrocution or excessive current.

Also in some cases, where there are circumstances when no protection is needed, the protector device 202 may merely provide electrical interconnection (of lines 108, 110) at the distribution panel, without protection circuitry for shunting hazardous signals to ground.

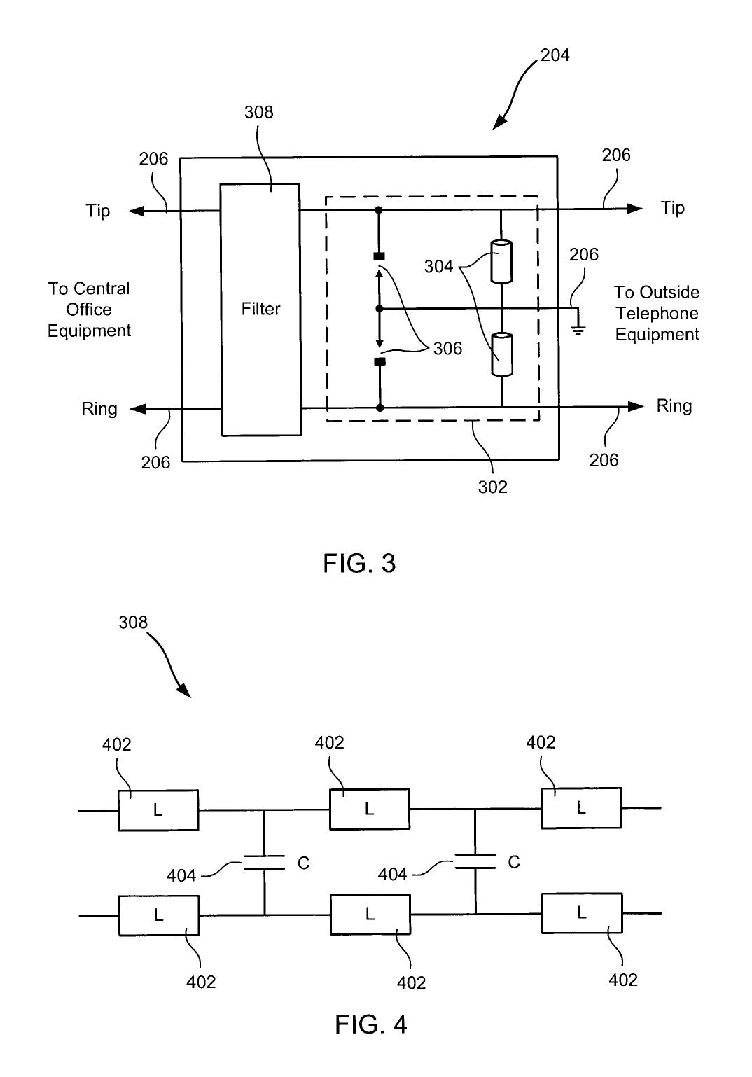

Referring now to FIG. 3, there is shown, in accordance with one embodiment of the present invention, the electrical components within the protector device 202 for protecting the network against hazardous signals present on the associated telecommunications lines 108, 110. The electrical components within the protector device 202 comprise a protective circuit 302 having two gas tubes 304, two metallic shunts 306, and a filter circuit 308.

Gas tubes 304 within the protective circuit 302 are surge suppression devices which clamp a surge voltage to a limited value. Gas tubes 304 are usually made up of two electrodes which are close together so that high voltages between the electrodes simply arc through air or other gas within the tube and are thereby shunted to ground. Metallic shunts 306 are conductors which melt (to complete an electrical path) at a predetermined excessive level of current and thereby shunt that current to ground.

The gas tubes 304 serve to shunt undesirable signals, usually of smaller magnitude and shorter duration. They do so repeatedly whenever such signals appear on the lines 108, 110. The metallic shunts 306, on the other hand, protect against larger and potentially more damaging signals, and once their conductive elements melt and conduct to ground, the protector device will no longer be operable to pass telephone signals between the central office and the subscriber (all signals are thereafter shunted to ground and the protector device 204 must be replaced in order for the telecommunications lines to pass telephone signals.)

It should be appreciated from the foregoing that the protector device 204 serves two purposes: (1) electrical connection of each central office line 108 to its associated outside line 110, and (2) protection of the network by shunting to ground any undesirable signals/currents/voltages passing through the lines 108, 110 at the distribution panel.

The protector device 204 as thus far described is conventional. For example, a protector device as described above is sold by Corning Cable Systems, formerly Siecor Corporation, Hickory, N.C., as gas tube protector modules (6A and 7A). Such protector devices are also described in various patents, such as U.S. Pat. No. 5,909,349.

In accordance with one embodiment of the present invention, the protector device 202 includes filter circuit 308. With filter circuit 308, the protector device 202 not only protects the network against hazardous or undesirable signals, but also restricts or blocks unpermitted frequencies present on the associated telecommunications lines 108, 110. The filter circuit 308 thus regulates the class of service provided over telecommunications lines 108, 110, and is illustrated in more detail in FIG. 4.

Referring now to FIG. 4, the filter circuit 308 includes inductors 402 and capacitors 404. Filter circuit 308 can be readily designed to pass or block frequencies depending on the class of service authorized to pass through the telecommunications lines to or from the subscriber. For purposes of illustration, the following Table 1 shows possible configurations (component values) of the filter circuit 308 for each of three possible classes of telecommunications service. It should be appreciated that various other filter configurations are possible for other classes of service (e.g., ISDN, SDSL, HDSL) using different values of capacitors and inductors, all within the scope of the present invention.

TABLE 1
Filter configurations - permitted service

| POTS | ADSL | VDSL |
|---|---|---|
| Plain Old (traditional) | Asymmetric Digital | Very high data rate Digital |
| Telephone Service | Subscriber Line | Subscriber Line |
| C = 0.001 μF | C = 0.0008 μF | C = 0.012 μF |
| L = 0.20 mH | L = 0.10 mH | L = 0.06 mH |

As an example, using Table 1 and in conjunction with Table 2 below, if a CLEC has purchased a local loop for use with POTS only, the protector device 202 of the present invention can be designed—by configuring the filter circuit 308 in accordance with Table 1—to block signal frequencies above 4 KHZ. However, as a further example, if the CLEC has purchased a local loop for use with VDSL, the filter circuit can be easily configured to block only signal frequencies above 12000 kHz. Therefore, the ILEC that has sold the local loop to the CLEC would be able to regulate the usage over the local loop.

For purposes of illustration, the following Table 2 shows the various signal frequencies for several representative classes of service available over telecommunications lines 108, 110. It should be appreciated that there are other levels of signal frequencies (for other classes of service) for which the filter circuit 308 could be designed.

TABLE 2
Spectrum Management Classes

| | |
|---|---|
| Service Type | Frequency in kHz |
| POTS | up to ˜4 |
| ADSL | between ˜25 and ˜1104 |
| VDSL | between ˜25 and ˜12000 |

Depending on the class of service “purchased” by a CLEC, the filter circuit 308 can be configured to pass and block a variety of signal frequencies. For example, if the CLEC has purchased a local loop for the purposes of using it to access POTS, which has a frequency of about 4 kHz, and ADSL, which has a frequency of between 25 kHz and 1104 kHz, the filter is configured to pass signal frequencies between 0 kHz and 1104 kHz and to block signal frequencies that are not in that range. Therefore, if the CLEC tried to circumvent the ILEC and attempted to use the local loop for a faster digital service such as VDSL, which has a frequency of between 25 kHz and 12000 kHz, the filter circuit 308 would block signal frequencies higher than 1104 kHz. Likewise if the CLEC purchased the local loop for the sole purpose of POTS, but later attempted to use the local loop as a digital subscriber line, the filter circuit 308 would block any unauthorized signal frequency above 4 kHz.

It can be seen from the foregoing that protector device 202 is used to connect and protect portions of a telecommunications network, such as central office lines 108, outside lines 110 and equipment connected thereto, from excessive voltage and/or excessive current. Protector device 202 also has the functionality (filter circuit 308) to block unauthorized signal frequencies from the telecommunications lines 108, 110.

While a detailed description of presently preferred embodiments of the invention have been given above, various alternatives, modifications, and equivalents will be apparent to those skilled in the art without varying from the spirit of the invention. It should be understood that various forms of network interconnection other than lines 108, 110 (twisted pairs) could be used to connect the central office to the outside equipment within the scope of the invention, such as wireless connections, coaxial cables, etc. It should also be appreciated that other forms of connectivity other than electrical pins 206 may be used to connect the protector device 202 to the distribution panel 104. These other forms might include as an example (and in lieu of pins 206), connections such as surface contacts present on the protector device 202 with corresponding surface contacts on the distribution panel 104, wherein the protector device 202 is clamped or otherwise held onto the distribution panel 104 (so that corresponding surface contacts are brought into electrical connection). Therefore, the above description should not be taken as limiting the scope of the invention, which is defined by the appended claims.

What is claimed is:

1. A telecommunications network, comprising:
a central office;
subscriber equipment;
a plurality of telecommunications lines interconnecting the central office and the subscriber equipment;
a plurality of protectors, each protector associated with one of the telecommunications lines and for protecting the network against undesirable signals present on the associated telecommunications line; and
a service regulating module associated and integral with at least one protector, for regulating the class of service provided over the telecommunications line associated with that one protector.

2. The telecommunications network of claim 1, wherein the service regulating module comprises a filter for passing signal frequencies representing an authorized class of service.

3. The telecommunications network of claim 1, wherein the protector is connected to each telecommunications line at a distribution panel.

4. The telecommunications network of claim 3, wherein the distribution panel is located at the central office and connects the telecommunications lines to a switch at the central office.

5. The telecommunications network of claim 2, wherein the service regulating module permits only low frequency telephone signals and the filter passes signals having a frequency less than approximately 4 kHz.

6. The telecommunications network of claim 2, wherein the service regulating module permits ADSL as the class of service and the filter passes signals having a frequency between approximately 25 kHz and 1104 kHz.

7. The telecommunications network of claim 2, wherein the service regulating module permits VDSL as the class of service and the filter passes signals having a frequency between approximately 25 kHz and 12000 kHz.

8. A protector device for being connected to a telecommunications line at a distribution panel in a telecommunications network, comprising:
a protective circuit for protecting the network against undesirable signals present on the telecommunications line; and
a service restricting circuit for restricting the class of service available via the telecommunications line, the service restricting circuit and the protective circuit both integrated within the protector device.

9. The protector device of claim 8, wherein the service restricting circuit comprises a filter for passing frequencies representing an authorized class of service.

10. A protector device for use in a telecommunications network, comprising:
a protector housing;
a protective circuit located within the protector housing for protecting the network against undesirable signals present on a telecommunications line in the network;
a plurality of electrical pins extending from the protector housing and for being inserted at a distribution panel in order to connect the protector device to the telecommunications line in the network; and
a service restricting circuit connected to the electrical pins, and for restricting the class of service available via the telecommunications line, the service restricting circuit and the protective circuit both integrated within the protector housing of the protector device.

11. The protector device of claim 10, wherein the service restricting circuit comprises a filter for passing signal frequencies representing an authorized class of service.

12. The protector device of claim 10, wherein the plurality of electrical pins comprise:
first and second tip pins;
first and second ring pins; and
a grounding pin.

13. A protector device for use in a telecommunications network, comprising:
means for protecting the network against undesirable signals present on telecommunications lines; and
means for restricting the class of service on the telecommunications lines, including filter means for blocking signals outside a predetermined permitted frequency.

14. A method for regulating classes of service over telecommunications lines, the method comprising:
providing a protector device for being connected to a telecommunications line and for protecting the telecommunications line against hazardous signals present on that telecommunications line; and
providing a service restricting circuit with the protector device, the service restricting circuit blocking certain classes of service, so that when the protector device is connected to the telecommunications line, certain classes of service are no longer available on that telecommunications line.

15. The method of claim 15, wherein the service regulating circuit comprises a filter for passing frequencies representing an authorized class of service.

16. A device for use at a distribution panel in a telecommunications network, comprising:
a connection circuit for connecting one telecommunications line at the distribution panel to a second telecommunications line at the distribution panel; and
a service restricting circuit for restricting the class of service available via the telecommunications lines, the service restricting circuit and the connection circuit both integrated within the device.
